(19) United States
(12) Patent Application Publication
(10) Pub. No.: US 2018/0025412 A1
(43) Pub. Date: Jan. 25, 2018

(54) DETERMINING IN-STORE LOCATION BASED ON IMAGES

(71) Applicant: Focal Systems, Inc., Millbrae, CA (US)

(72) Inventors: Francois Chaubard, Millbrae, CA (US); Adriano Quiroga Garafulic, Sao Paulo (BR)

(21) Appl. No.: 15/656,922

(22) Filed: Jul. 21, 2017

Related U.S. Application Data
(60) Provisional application No. 62/365,750, filed on Jul. 22, 2016.

(51) Int. Cl. G06Q 30/06; G06K 9/00; G06N 99/00

(52) U.S. Cl. CPC G06Q 30/0639; G06N 99/005; G06K 9/00771; G06K 2209/01

(57) ABSTRACT

An in-store location system determines the location of a shopper within a store based on images received from a shopper client device. The shopper client device can be attached to a shopping cart and may be connected to one or more cameras that capture images of products on shelves. The in-store location system can detect products in images received from the shopper client device using a machine-learned product detection model to detect the products in the received images. The in-store location system can then determine the location of the shopper within the store based on the received images. The in-store location system may compare the detected products to a store map or a planogram describing the store. The in-store location system also may apply a machine-learned location-determination model to the received images.

### CROSS REFERENCE TO RELATED APPLICATION

This application claims to the benefit of U.S. Provisional Patent Application No. 62/365,750, filed on Jul. 22, 2016, the contents of which are herein incorporated by reference in their entirety.

### BACKGROUND

A store may use an in-store location system to determine the location of shoppers within the store. For example, an in-store location system may use radio-frequency identification (RFID) technology to determine a shopper's location. By installing a large amount of active or passive RFID tags throughout the store at known locations, a device associated with a shopper could detect a specific RFID tag when in close proximity to it, and would then determine where the shopper is located. However, accurately placing an RFID tag in many locations in the store is a labor-intensive process and may require a skilled technician for accurate placement. Also, RFID antennas can be expensive, and providing an RFID antenna and receiver to every shopper in the store or putting an active RFID tag at a multitude of locations in a store can be cost prohibitive. Finally, if passive RFID tags are ever moved or misplaced, the accuracy of the location calculations can be detrimentally impacted.

Other solutions may rely on readings of an electromagnetic wave, such as magnetometer readings of naturally-occurring geomagnetic flux, the measurement of multiple Wi-Fi routers signal strength, or the use of Bluetooth or iBeacon technology to measure Bluetooth packet signal strength. However, these solutions can be inaccurate. Since the Free Space Path Loss (FSPL) of all propagated electromagnetic wave is proportional to the squared distance between the transmitter and receiver, the error of these methods grows quadratically with distance, meaning the accuracy of these methods can be poor. Rather than a backsolving/triangulation method, some algorithms that rest on electromagnetic wave readings use a “fingerprinting” method, which use the concatenated received signal strength of many transmitters as a vector in a vector space such that any set of measured received signal strengths arranged into a vector close to a labeled truth vector must be at the same location. However, this method can still be inaccurate, and requires a large number of transmitters to achieve better accuracies than triangulation.

Furthermore, a weakness common to all previous methods is the inability to estimate the angle of orientation of the device in free space. Knowing the position and orientation is much more preferred than just the position alone, however any electromagnetic wave based method would be unable to gather orientation.

### SUMMARY

An in-store location system determines the location of a shopper within a store based on images captured by a shopper client device operated by the shopper. The shopper client device can be configured to capture images of products near the shopper. For example, the shopper client device may include or be connected to one or more cameras that capture images of products on shelves in the store. In some embodiments, the shopper client device is attached to a shopping unit (e.g., a shopping cart or a hand-held shopping basket), and the shopper client device is connected to one or more cameras that are also attached to the shopper unit and are directed outwards from the shopping unit.

The in-store location system receives an image from the shopper client device and detects the products that are described by the image. In some embodiments, the in-store location system may detect the products that are described by the image using an optical character recognition algorithm that identifies product brands or names in the image. The in-store location system also may use a product-detection model to detect products in an image. A product-detection model may be a machine-learned model that is trained based on reference images captured by a store associate using a store client device. Reference images can describe products on shelves of the store, and may include bounding boxes that identify portions of the reference images that describe products. The reference images may also be associated with location information that describes the location within the store of where the reference image was taken.

The in-store location system can determine the location of the shopper based on the products detected in the image captured by the shopper client device. The in-store location system can compare the detected products to a store map or a planogram associated with the store to determine the location of the shopper. The in-store location system also may use a location-detection model to determine the location of the shopper. The in-store location model may be trained based on reference images captured by a store associate and location information associated with the reference images. The in-store location system may provide the shopper's location to the shopper client device or a store client device for presentation to the shopper or a store associate, respectively.

By using images to determine the location of a shopper, the in-store location system can determine the location of a shopper within a store without requiring that expensive hardware be installed in the store. Additionally, the in-store location system can more accurately determine the location of the shopper than by using RFID technology or by taking readings of electromagnetic waves. Also, the in-store location system may determine the orientation of the shopper as well. Therefore, the in-store location system can determine a shopper's location for various applications.

### BRIEF DESCRIPTION OF THE DRAWINGS

FIG. 1 illustrates an example system environment and architecture for an in-store location system, in accordance with some embodiments.

FIG. 2 illustrates an example layout of a store, in accordance with some embodiments.

FIG. 3 illustrates an example user interface for a store client device to capture images of and label products on shelves of a store, in accordance with some embodiments.

FIG. 4 is a flowchart for a method of determining in-store location based on images captured by the shopper client device, in some embodiments.

### DETAILED DESCRIPTION

### Example System Environment and Architecture

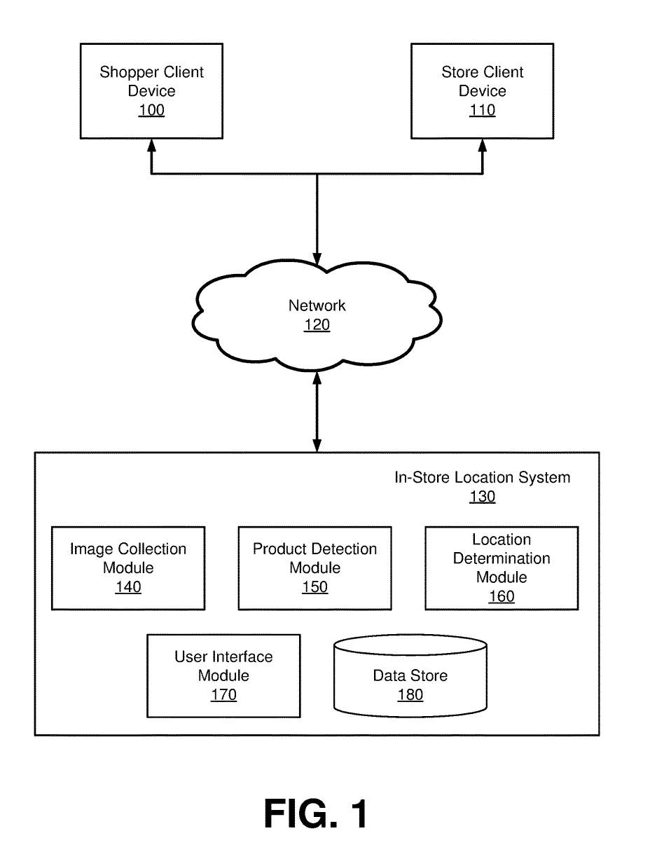

FIG. 1 illustrates a system environment for an in-store location system, in accordance with some embodiments. FIG. 1 includes a shopper client device 100, a store client device 110, a network 120, and an in-store location system 130. Alternate embodiments may include more, fewer, or different components and the functionality of the illustrated components may be divided between the components differently from how it is described below. For example, while only one shopper client device 100 and store client device 110 is illustrated, alternate embodiments may include multiple shopper client devices 100 and store client devices 110. Additionally, the functionality of the store client device 110 may be performed by one or more store client devices 110.

The shopper client device 100 collects information required by the in-store location system 130 to determine the shopper's location within the store and presents information to the shopper from the in-store location system 130. In some embodiments, the shopper client device 100 is a personal or mobile computing device, such as a smartphone, a tablet, a laptop computer, or a desktop computer. Alternatively, the shopper client device 100 can contain specialized hardware for performing the functionality described herein. In some embodiments, the shopper client device 100 can execute a client application for the in-store location system 130. For example, if the shopper client device 100 is a mobile device, the shopper client device 100 may execute a client application that is configured to communicate with the in-store location system 130.

The shopper client device 100 is attached to a shopping unit that the shopper uses to hold products that the shopper purchases from the store. For example, the shopper client device 100 may be attached to a hand-held shopping basket or a shopping cart. The shopper client device 100 may be temporarily attached to the shopping unit (e.g., by holding the shopper client device 100 in a mount) or may be permanently attached to the shopping unit (e.g., via a bracket, a strap, screws, bolts, or an adhesive).

The shopper client device 100 can include a camera that is used to capture images of products that are physically located near the shopper. The shopper client device 100 may be attached to the shopping unit such that the camera is directed toward shelves of the store as a shopper traverses through the store. For example, if the shopper client device 100 is a mobile device, the shopper client device 100 may be held in a mount such that the camera of the shopper client device 100 is directed toward the store shelves as the shopper traverses through the store. In some embodiments, the shopper client device 100 is connected to one or more cameras that are mounted to the shopper unit and that capture images around the shopping unit. The camera may capture images on a regular time intervals or in response to determining that the shopper has moved within the store. In some embodiments, the shopper client device 100 collects additional information used by the in-store location system 130 to determine the location of the shopper. For example, the shopper client device 100 can collect motion data (e.g. from an accelerometer) to infer when the shopper is moving around the store. The shopper client device 100 may also send information about the shopper client device 100 to the in-store location system 130, such as a unique device ID, battery level, external battery connection, IP address, software version number, or whether the device is being used. The shopper client device 100 may also send information about a shopper's trip through the store, such as the number times the shopper interacts with the shopper client device 100, the time the shopper spends in the store, and the products the shopper searches for or interacts with through the shopper client device 100.

The shopper client device 100 can include a display to present the shopper with a user interface for interacting with the shopper client device 100. For example, the shopper client device 100 may present a user interface that includes a map of the store and indicates the shopper's location within the store. The shopper client device 100 also may allow the shopper to search for products in the store, through a search bar, voice search via a speech-to-text API, or a barcode scanner. The shopper client device 100 may then display the products on a map of the store along with information about each product, such as a description of each product or an image. The shopper client device 100 may also provide directions to the shopper to travel to products or departments within the store.

The store client device 110 receives information about the status of the store from the in-store location system 130 and presents the information to a store associate (e.g., a store owner, manager, or employee). For example, the store client device 110 may present a store associate with information about where shoppers are located within the store, how shoppers travel through the store, whether products need to be restocked, or planogram compliance errors. The store client device 110 also can be used to update product information for the store in the in-store location system 130.

A store associate can also use the store client device 110 to capture reference images of the store for the in-store location system 130. Reference images are images of products on shelves within the store for training the in-store location system 130. Each reference image is associated with location information describing the location within the store that the reference image was taken. The location information may include an aisle within which the reference image was taken, a position within an aisle, a department within the store, a GPS location, or an orientation at which the reference image was captured. The location information for each reference image may also include an angle or direction at which the reference image was taken. In some embodiments, the store associate manually provides the location information of a reference image through the shopper client device 110. For example, the shopper client device 110 may display a user interface with a map of the store on which the store associate can indicate location information for a reference image. Alternatively, the shopper client device 110 may determine the location information for a reference image based on a start point within the store, an end point within the store, and motion data collected from an accelerometer, GPS sensor, or an electronic compass. In some embodiments, the shopper client device 110 determines the location information using a location gathering method (e.g., SLAM (Synchronous Location and Mapping), high powered antennas, or dead reckoning methods). Additionally, the reference images may be captured by the shopping client device 100 as the shopper travels throughout the store.

The shopper client device 100 and the store client device 110 can communicate with the in-store location system 130 via the network 120, which may comprise any combination of local area and wide area networks employing wired or wireless communication links. In one embodiment, the network 120 uses standard communications technologies and protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any format, such as hypertext markup language (HTML) or extensible markup language (XML). In some embodiments, all or some of the communication links of the network 120 may be encrypted.

The in-store location system 130 determines the location of a shopper within the store based on images received from the shopper client device 100. The in-store location system 130 may be located within the store or remotely. FIG. 1 illustrates an example system architecture of an in-store location system 130, in accordance with some embodiments. The in-store location system 130 illustrated in FIG. 1 includes an image collection module 140, a product detection module 150, a shopper location module 160, a user interface module 170, and a data store 180. Alternate embodiments may include more, fewer, or different components from those illustrated in FIG. 1, and the functionality of each component may be divided between the components differently from the description below. Additionally, each component may perform their respective functionalities in response to a request from a human, or automatically without human intervention.

The image collection module 140 collects images from the shopper client device 100 and the store client device 110. The image collection module 140 can also receive location information associated with the received images. The image collection module 140 stores collected images and location data in the data store 190. In some embodiments, the image collection module 140 filters out unsatisfactory reference images received the store client device 110. For example, if a reference image is blurry, out of focus, or over- or under-exposed, or if the image does not show a sufficient portion of the shelf, the image collection module 140 may reject the reference image. If the rejected image is a reference image, the image collection module 140 can prompt the store associate to retake the rejected image using the store client device 110. In some embodiments, the image collection module 140 collects additional information from the shopper client device 100

The product detection module 150 detects products in images captured by the shopper client device 100 or the store client device 110. For each product detected in the images, the product-detection module 150 can identify a location on the shelves of the detected product and a likelihood that the product prediction is accurate. In some embodiments, the product detection module 150 detects products within the images by requesting that the shopper or the store associate identify the products in the images using the shopper client device 100 or the store client device 110. Alternatively, the product detection module 150 can identify products in the received images automatically. For example, the product detection module 150 may apply an optical character recognition (OCR) algorithm to the received images to identify text in the images, and may determine which products are captured in the image based on the text (e.g., based on whether the text names a product or a brand associated with the product). The product detection module 150 also may use a barcode detection algorithm to detect barcodes within the images and identify the products based on the barcodes. For example, store shelves may display a barcode for each product on the shelves, and the product detection module 150 may identify the product above each barcode as the product associated with the barcode.

In some embodiments, the product detection module 150 uses a machine-learned product-detection model to detect the products in the images. The product-detection model can be trained based on reference images that have been labeled by the store associate. In some embodiments, the product-detection model is trained based on labeled images of the products offered for sale by the store. The product-detection model identifies the products in the images and where those products are located on the shelves. In some embodiments, the product-detection model generates bounding boxes for each product and determines a likelihood that the product-detection model's prediction is correct. The product-detection model can be a convolutional neural network that has been trained based on the references images

The location determination module 160 determines the location of a shopper within the store based on images received from the shopper client device 100. The shopper's location may include location information, such as shopper's location relative to features within the store, the shopper's GPS position, or the shopper's orientation. The location determination module 160 may additionally determine the location of a shopper based on products detected in images received from the shopper client device 100. The location determination module 160 may compare an image received from the shopper client device 100 with reference images received from the store client device 110. The location determination module 160 may then identify a reference image most similar to the image received from the shopper client device 100 and may determine the shopper's location in the store based on the location information associated with the identified reference image.

In some embodiments, the location determination module 160 generates a machine-learned location-determination model that determines the location of the shopper based on images received from the shopper client device 100. The location-determination model can be trained based on reference images, the products detected in the reference images, and location information associated with the reference images. In some embodiments, the location-determination model is a classification model trained to identify a number of classes equal that is equal to a number of locations within a store. The classification model can determine a discrete probability distribution over all the known locations and orientations based on images received from the shopper client device 100, and may then use the raw output and maximum probability to determine the shopper's locations orientation. In some embodiments, the location-determination model uses a probabilistic smoothing algorithm to determine the shopper's location based on the classification probabilities of the shopper's previous location. The probabilistic smoothing algorithm can include a Hidden Markov Model or a Kalman Filter. The location-determination model may also be trained based on a planogram associated with the store that describes where products are located in the store. In some embodiments, the location-determination model reduces the dimensionality of the images to a vector containing fewer feature dimensions than the images received from the shopper client device 100. The location-determination model can compare the vector associated with an image from the shopper client device 100 with a vector associated with a reference image to determine the location of the shopper within the store.

The user interface module 170 interfaces with the shopper client device 100 and the store client device 110. The interface generation module 170 may receive and route messages between the in-store location system 130, the shopper client device 100 and the store client device 110, for example, instant messages, queued messages (e.g., email), text messages, or short message service (SMS) messages. The user interface server 140 may provide application programming interface (API) functionality to send data directly to native client device operating systems, such as IOS®, ANDROID™, WEBOS® or RIM®.

The user interface module 170 generates user interfaces, such as web pages, for the in-store location system 130. The user interfaces are displayed to the shopper or the store associate through a shopper client device 100 or the store client device 110, respectively. The user interface module 170 configures a user interface based on the device used to present it. For example, a user interface for a smartphone with a touchscreen may be configured differently from a user interface for a web browser on a computer.

The user interface module 170 can provide a user interface to the store client device 110 for capturing reference images of store shelves that hold products for sale by the store. Additionally, the user interface module 170 may provide a user interface to the store client device 110 for labeling products in reference images. The user interface module 170 receives images from the shopper client device 100 and the store client device 110 and stores the images in the data store 180.

The data store 180 stores data used by the in-store location system 130. For example, the data store 180 can store images from the shopper client device 100 and the store client device 110. The data store 180 can also store location information associated with reference images, and can store products identified in images by the product detection module 150. The data store 180 can also store product information, a store map or planogram, customer information, or customer location information. In some embodiments, the data store 180 also stores product-detection models or location-determination models generated by the in-store location system 130.

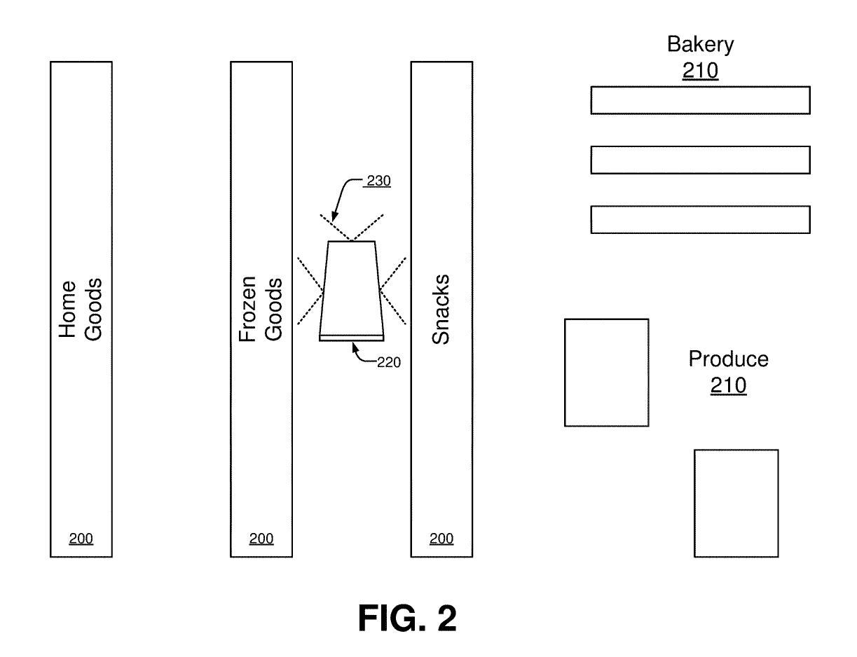

FIG. 2 illustrates an example layout of a store, in accordance with some embodiments. The illustrated store includes aisles 200 and departments 210 within the store that display products of a certain type. FIG. 2 also illustrates a shopping unit 220 that is passing between aisles of the store. As described above, the shopping unit 220 can include a shopper client device connected to one or more cameras 230 that are directed outwards from the shopping unit. The cameras 230 are configured to capture images of products on shelves within the store. The shopper client device can transmit the captured images to an in-store location system to determine the location of the shopper within the store.

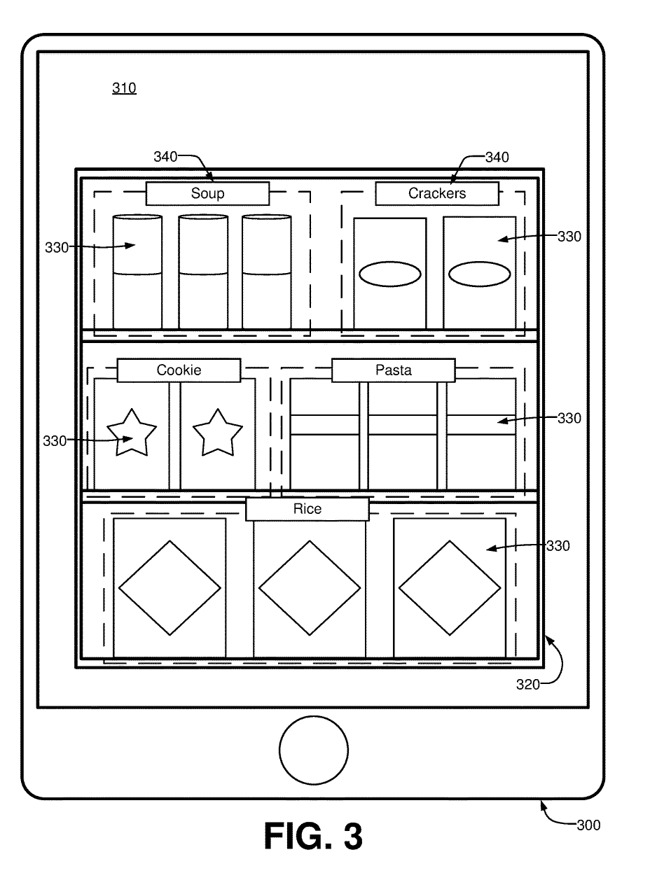

FIG. 3 illustrates an example user interface for a store client device 300 to capture images 310 of and label products on shelves 320 of a store, in accordance with some embodiments. A store associate can use a camera of the store client device 300 to capture images 310 of the shelves 320. The images can illustrate products 330 that are offered by the store. The store associate can use the store client device 300 to label the products 330 by generating labeled bounding boxes 340 that label the portions of the images 310 that represent each product. The labeled images can be transmitted to an in-store location system to train a machine-learned product-detection model.

### Example Flow Chart

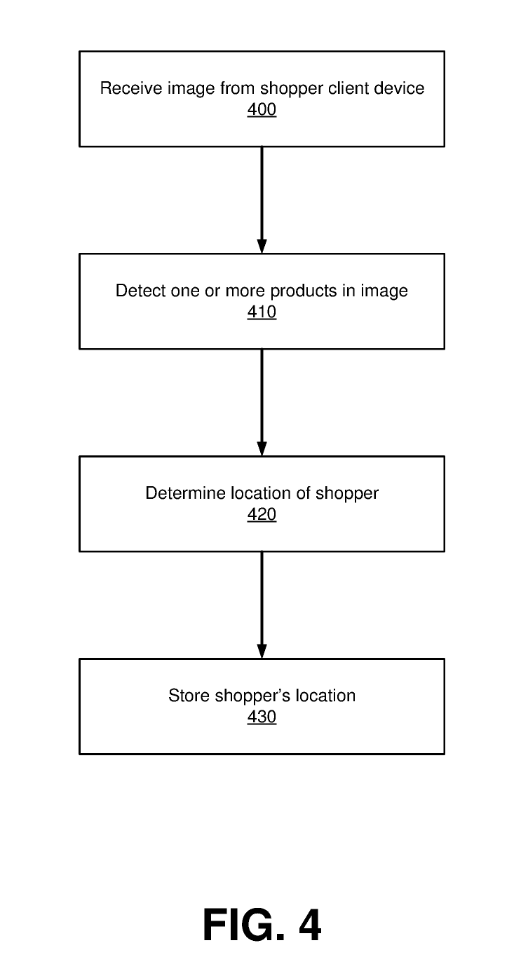

FIG. 4 is a flowchart for a method of determining in-store location based on images captured by the shopper client device, in some embodiments. Alternate embodiments may include more, fewer, or different steps from those illustrated in FIG. 4, and the steps may be performed in a different order from that illustrated in FIG. 4. Additionally, each of these steps may be performed automatically by the in-store location system without human intervention.

The in-store location system receives 400 an image from the shopper client device. The shopper client device can be attached to a shopping unit, and can include or be connected to one or more cameras that are directed outward from the shopping unit. The in-store location system detects 410 one or more products that are described in the image. The in-store location system may detect the product by applying a product-detection model to the image. The product-detection model may be trained based on reference images captured by a store client device operated by a store associate.

The in-store location system determines 420 the location of the shopper within the store based on the received image. The in-store location system can determine the shopper's location based on the products identified in the image. In some embodiments, the in-store location system compares the products identified in the received image with products in reference images captured by the store client device, and uses the location information associated with the reference images to determine the shopper's location. In some embodiments, the in-store location system applies a location-determination model to the received image or the detected products to determine the shopper's location in the store.

The in-store location system stores 430 the shopper's location. The in-store location system may transmit the shopper's location to the shopper client device. The shopper client device may present the shopper's location to the shopper via a display. In some embodiments, the in-store location system transmits the shopper's location to the store client device for presentation to a store associate.

### Additional Applications

The in-store location system can use the shopper's in-store location to provide additional services to the shopper or the store associate. For example, the in-store location system can receive an identifier from the shopper client device that identifies a product offered by the store or a department within the store. The in-store location system can determine a route through the store from the shopper's location to the location of the identified product or department and can present the route to the shopper via the shopper client device. In some embodiments, the shopper client device allows the shopper to select a product or a department by providing a search keyword and selecting the product or department from search results generated by the in-store location system.

In some embodiments, the in-store location system can determine whether a product is out of stock based on the shopper's location. As described above, the in-store location system can detect products in images captured by the shopper client device. The in-store location system can determine which products are near the shopper based on images received from the shopper client device. The in-store location system can determine whether a product is out of stock based on whether the in-store location system detects a product near the shopper when the shopper is near where the product should be displayed. For example, if the in-store location system does not detect the product where the product should be displayed, the in-store location system may label the product as out-of-stock and may alert a store associate via the store client device. The in-store location system may determine where a product should be displayed within the store based on a store map or a planogram, which can describe the locations of products within the store.

Similarly, the in-store location system can determine whether the store is in compliance with a planogram. If the in-store location system determines that a product is displayed in a location within the store different from where the product should be displayed based on the planogram, the in-store location system can notify a store associate via the store client device that the store is out of compliance with the planogram.

The in-store location system can also display product information to the shopper based on the shopper's location. For example, the in-store location system may determine which products are near the shopper's location and may display information describing the products on the shopper client device. The in-store location system may display recommended products to the shopper, products that are on sale, or products that are available for a limited time. The in-store location system may also display coupons for products that are near the shopper to encourage the shopper to purchase those products.

The in-store location system additionally may provide shopper behavior information to the store associate via the store client device. The shopper behavior information can include a heat map of where shoppers tend to be in the store, information describing the paths of travel of shoppers as the travel through the store, where shoppers tend to pause in walking, or which aisles tend to have the most shoppers. The in-store location system also may provide the store associate with real-time locations of shoppers currently in the store.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving an image from a shopper client device associated with a shopper, the image capturing one or more products offered for sale by a store;
detecting the one or more products described in the image;
determining a location of the shopper within the store based on the detected one or more products; and
storing the location of the shopper at an in-store location system.

2. The method of claim 1, wherein the image is captured via a camera of or connected to the shopper client device.

3. The method of claim 1, wherein the shopper client device is attached to a shopping unit being used by the shopper.

4. The method of claim 1, wherein determining the location of the shopper comprises:
comparing the received image to one or more references images received from a store client device operated by a store associate.

5. The method of claim 1, wherein determining the location of the shopper comprises:
applying a location-determination model to the received image.

6. The method of claim 5, wherein the location-determination model is trained based on reference images captured by a store client device.

7. The method of claim 6, wherein the location-determination model is trained based on location information associated with each reference image of the reference images.

8. The method of claim 1, wherein detecting the one or more products comprises:
applying a product-detection model to the received image.

9. The method of claim 8, wherein the product-detection model is trained based on reference images received from a store client device.

10. The method of claim 9, wherein training the product-detection model comprises:
receiving boundary boxes from a store client device, each boundary box indicating a portion of the received image that represents a product.

11. The method of claim 1, wherein detecting the one or more products comprises:
applying an optical character recognition algorithm to the received image.

12. The method of claim 1, further comprises:
receiving an identifier identifying a product within the store; and
transmitting, to the shopper client device for presentation to the shopper, a route from the location of the shopper to a location of the product within the store.

13. The method of claim 1, further comprising: determining that a product is out of stock based on whether the product is detected in the image.

14. The method of claim 1, further comprising: determining that the store is out of compliance with a planogram associated with the store based on the detected one or more products.

15. The method of claim 1, further comprising: determining shopper behavior of the shopper based on the location of the shopper.

16. The method of claim 1, further comprising: transmitting product information to the shopper client device, the product information being associated with a product of the detected one or more products.

17. The method of claim 1, further comprising: transmitting the location of the shopper to the shopper client device for presentation to the shopper.

18. A non-transitory, computer-readable medium comprising instructions that, when executed by a processor, cause the processor to:
receive an image from a shopper client device associated with a shopper, the image capturing one or more products offered for sale by a store;
detect the one or more products described in the image;
determine a location of the shopper within the store based on the detected one or more products; and
store the location of the shopper at an in-store location system.

19. The computer-readable medium of claim 18, wherein the instructions for determining the location of the shopper comprise instructions that cause the processor to: apply a location-determination model to the received image.

20. The computer-readable medium of claim 18, wherein the instructions for detecting the one or more products comprise instructions that cause the processor to: apply an optical character recognition algorithm to the received image.
